(19) United States
(12) Patent Application Publication
(10) Pub. No.: US 2023/0395847 A1
(43) Pub. Date: Dec. 7, 2023

(54) POLYMER ELECTROLYTES WITH IMPROVED IONIC CONDUCTIVITY

(71) Applicant: Ionic Materials, Inc., Woburn, MA (US)

(72) Inventors: Sipei Li, Woburn, MA (US); Mohamed Taggougui, Woburn, MA (US); Andrew Paul Leitner, Woburn, MA (US); Ahmed Al-Obeidi, Woburn, MA (US)

(73) Assignee: Ionic Materials, Inc., Woburn, MA (US)

(21) Appl. No.: 18/134,709

(22) Filed: Apr. 14, 2023

Related U.S. Application Data
(60) Provisional application No. 63/330,940, filed on Apr. 14, 2022.
(60) Provisional application No. 63/443,538, filed on Feb. 6, 2023.

(51) Int. Cl. H01M 10/0565

(52) U.S. Cl. CPC H01M 10/0565; H01M 2300/0082

(57) ABSTRACT

Electrodes are disclosed that include a polymer electron donor, an electron acceptor, a lithium salt, and a solvent. In select embodiments, the components of the electrode may form a charge-transfer complex polymer (CTCP) to achieve high local lithium concentration and endow fast lithium mobility. In another aspect, an improved polymer electrolyte that uses block copolymers composed of monomers is described in which one of the monomers contains electron-rich pi systems and the other of the monomers contains electron-poor pi systems. The block copolymers may be combined with a salt to form the polymer electrolyte.

### CROSS-REFERENCE TO RELATED APPLICATIONS

This application claims the benefit of U.S. Provisional Patent Application No. 63/330,940, titled CHARGE-TRANSFER POLYMER CO-ELECTROLYTES, filed Apr. 14, 2022, and U.S. Provisional Patent Application No. 63/443,538, titled POLYMER ELECTROLYTE COMBINING ELECTRON POOR AND ELECTRON RICH PI GROUPS, filed Feb. 6, 2023, the disclosures of which are herein incorporated by reference in their entireties.

### FIELD OF TECHNOLOGY

The present disclosure is in the field of composite solid-state electrolytes, and more particular in the field of composite solid-state electrolytes with improved ionic conductivity.

### BACKGROUND

Solid-state lithium batteries are regarded as the future of energy storage due to their advantages in safety and energy density. The key to the success of solid-state batteries is the implementation of a highly conductive solid electrolyte. A polymer electrolyte is one of the top candidates for achieving this outcome. However, polymer electrolytes traditionally suffer from low ionic conductivity (<10⁻⁵ S/cm), especially at room temperature, since ion transport in a conventional polymer electrolyte depends on segmental motion of the polymer chain.

### SUMMARY

In one aspect, the present disclosure is directed to electrodes useful in electrochemical cells. The electrodes may include a polymer electron donor, an electron acceptor, a lithium salt, and a solvent in some embodiments. In select embodiments, the polymer electron donor may be polyphenylene sulfide (PPS), polymethylphenylsilane (PMPS), and/or poly(ethylene oxide) (PEO). In these and other embodiments, the electron acceptor may be Chloranil, Fluoranil, N,N′-bis(2-phosphonoethyl)-1,4,5,8-naphthalenediimide (PNDI), 2,3-Dichloro-5,6-dicyano-1,4-benzoquinone (DDQ), and/or an oxidizing agent. The lithium salt may be Lithium bis(trifluoromethanesulfonyl)imide (LiTFSI), in some embodiments. The solvent may be one or more of the following: tetrahydrofuran (THF), SN, EC, BMP TFSI (IL), and/or G4. The components of the electrode may or may not form a charge-transfer complex (CTC).

In select embodiments, the electrolytes may include a charge-transfer complex polymer (CTCP) and one or more additives to achieve high local lithium concentration and endow fast lithium mobility. In some such embodiments, the CTCP enhances the high local lithium concentration due to an overlapping of a double electric layer. According to some implementations, the high local lithium concentration originating from the CTCP and the high lithium mobility originating from the addition of one or more additives provides high lithium-ion conductivity.

In another aspect, an improved polymer electrolyte that uses block copolymers composed of monomers is described in which one of the monomers contains electron-rich pi systems and the other of the monomers contains electron-poor pi systems. The block copolymers may be combined with a salt to form the polymer electrolyte. In some embodiments, one of the polymers containing electron-rich pi systems is combined and blended with another polymer containing electron-poor pi systems. The blended polymers are combined with a salt to create a polymer electrolyte. The disclosed mixtures of electron-poor pi groups and electron-rich pi grounds are capable of dissociating the salts more easily than either of the polymer blocks could on its own. According to another aspect of the present disclosure, the disclosed polymer/salt matrix can be maintained above the glass transition temperature to work well and have even further improved ionic conductivity. Compared to previously known techniques, embodiments of the present disclosure have the advantage of not requiring additional dissociating solvents such as carbonates, water or nitriles to provide sufficient ionic conductivity at room temperature.

The disclosed polymer electrolytes may have an ionic conductivity of at least 1×10⁻⁴ S/cm or at least 1×10⁻³ S/cm at room temperature (25° C.). In select embodiments, the polymer electrolyte may contain between 0.5 wt %-50 wt % solvent, such as between 0.5 wt %-5 wt %, 0.5 wt %-15 wt %, 5 wt %-25 wt %, or 10 wt %-30 wt % solvent.

The presently disclosed electrolytes can be prepared by any suitable technique. For example, in some embodiments, the electrolytes are prepared by speed mixing. In select embodiments, a high shear mixer is used to prepare the electrolytes.

These and other aspects, features, advantages, and objects will be further understood and appreciated by those skilled in the art upon consideration of the following specification and enclosed drawings.

### BRIEF DESCRIPTION OF THE DRAWINGS

FIG. 1 shows a schematic diagram of a charge transfer complex (CTC) in accordance with some embodiments of the subject disclosure;

FIG. 2 shows a schematic diagram of a diffuse electric double layer (EDL) in accordance with some embodiments of the subject disclosure;

FIG. 3 shows a schematic diagram of lithium-ion concentration as a function of Debye length;

FIG. 4A shows a schematic diagram of an electric double layer in a polymer-based charge transfer complex in the presence of a lithium salt, in accordance with some embodiments;

FIG. 4B shows a schematic diagram of a charge-transfer complex polymer (CTCP) interface and lithium mobility through the addition of electrolyte additives, in accordance with some embodiments of the present disclosure;

FIG. 5 shows the chemical structures of various components of the disclosed polymer electrolytes, in accordance with some embodiments of the present disclosure;

FIG. 6A shows UV/Vis spectra for polymer electrolytes configured in accordance with embodiments of the present disclosure;

FIG. 6B shows a schematic diagram of how a lithium-ion salt disrupts CTC formation;

FIG. 7A-7D show conductivity measurements for various polymer electrolytes having differing amounts of solvent, in accordance with embodiments of the present disclosure;

FIG. 8A-8B show conductivity measurements for polymer electrolytes having differing types of solvent, in accordance with some embodiments of the present disclosure;

FIG. 9 shows conductivity measurements for polymer electrolytes having different amounts of salt, in accordance with embodiments of the subject disclosure;

FIGS. 10A-10D show conductivity measurements for polymer electrolytes having different types and amounts of electron acceptor, in accordance with some embodiments of the present disclosure;

FIGS. 11A-11C show conductivity data for various polymer electrolytes configured in accordance with embodiments of the present disclosure;

FIG. 12 shows conductivity data for various polymer electrolytes configured in accordance with embodiments of the present disclosure;

FIG. 13 shows conductivity data for various polymer electrolytes configured in accordance with embodiments of the present disclosure; and

FIG. 14 shows a chemical reaction diagram for forming a polymer electrolyte with electron-poor and electron-rich pi groups, in accordance with some embodiments of the present disclosure.

### DETAILED DESCRIPTION

The present disclosure includes a composite solid-state electrolyte with improved ionic conductivity. The solid-state electrolyte can achieve high local lithium concentration with high lithium mobility. In some embodiments, a charge-transfer complex polymer (CTCP) with additives that endow fast lithium mobility is used to form a polymer electrolyte. However, in other embodiments, the polymer electrolyte does not form a charge-transfer complex (CTC) and an oxidizer is used to cause charge delocalization to provide improved ionic conductivity. Numerous variations are possible and discussed in detail herein.

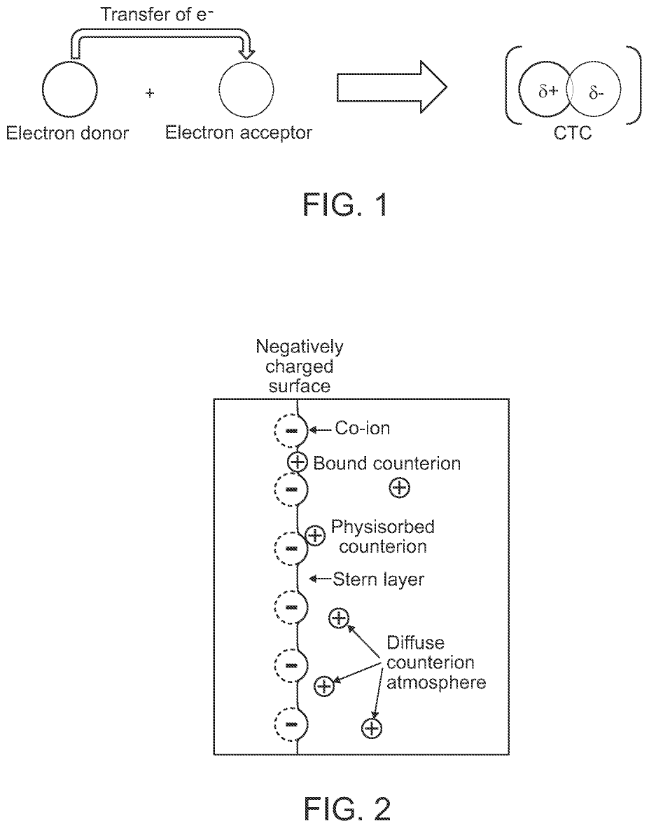

As a preliminary matter, charge separation between electron donors and electron acceptors can be used to form a charge transfer complex (CTC). FIG. 1 shows a schematic diagram an example CTC, illustrating charge separation between electron donor and electron acceptor upon formation of the CTC. A proposed mechanism for the enhancement effect involves the formation of an electric double layer (EDL) that enhances the conductivity and the transference number. When a CTC forms, electron density is shifted from donor to acceptor—causing partial charge separation. In the case of a polymer electron donor and a small molecule electron acceptor (for example, PPS/chloranil), the electron density is shifted from PPS backbone to the chloranils, as shown in FIG. 2. As a result, the polymer backbones are positively charged and the chloranil near the backbone will be negatively charged, causing a negatively charged surface.

It is expected that the negative surface charges will therefore adsorb positive ion (Li⁺ in case of lithium salt) to counter-balance the negative surface charge. Some of the Li⁺ will be transiently physiosorbed to the surface forming a Stern layer while other Li⁺ ions will form an layer with rapid thermal motion, therefore forming a diffuse electric double layer (EDL), as shown in FIG. 2, and the length of the EDL is characterized by the Debye screening length, 1/κ.

The concentration of Li⁺(ρₓ) in the EDL (Boltzmann distribution) should be expressed as:

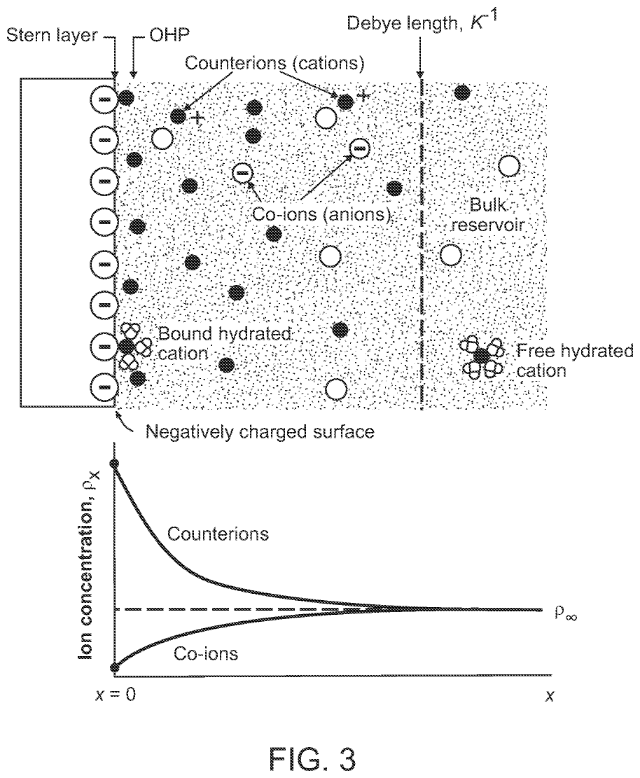

ρₓ=ρ_{∞}e^{-φ}^{ₓ}^{/kT}

Where x is the distance from the surface; φₓ is the electrostatic potential at position x. As shown in FIG. 3, within the Debye length κ⁻¹, the local lithium ions will always be higher than counter anions and concentration of lithium ions in bulk electrolytes.

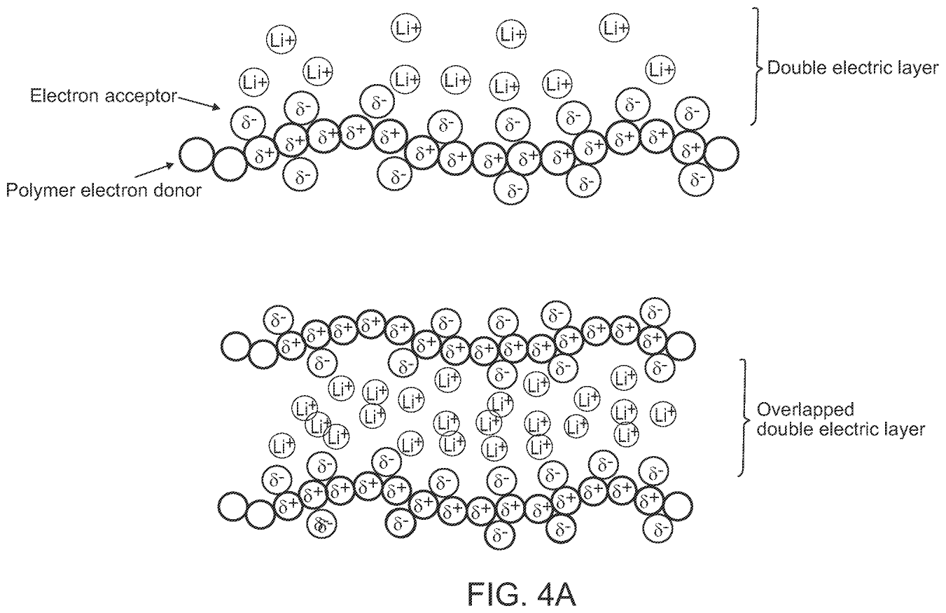

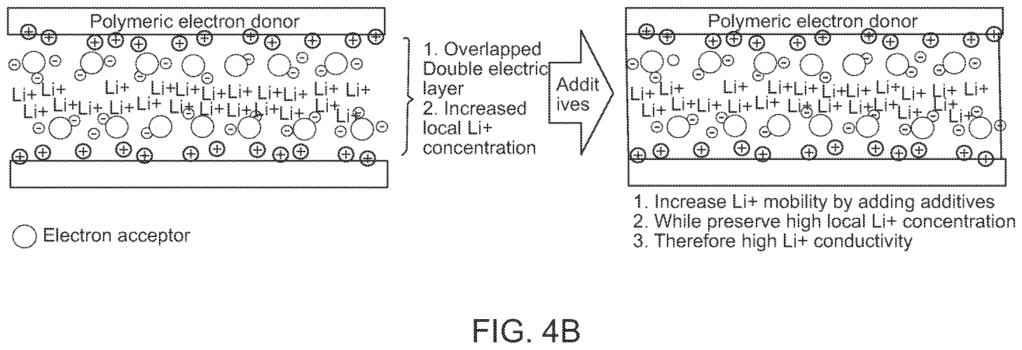

Therefore, when the polymer chains are close enough to each other, meaning that the EDL from the two surfaces starts to overlap, the concentration of Li⁺ between polymer chains would be expected to be greatly enhanced and the concentration of counter ions became lower than that in the bulk electrolyte (see FIG. 4A).

According to Goyu-Chapman model, the size of the EDL is inversely proportional to the concentration of lithium ions:

κ⁻¹=(ϵ₀ϵkT/2ρ_{∞}e²)^{1/2}

As a result, for Debye length to effectively overlap at practical concentration, the length between polymer chains need to be sub-nanometer.

According to

$$δ = \frac{{F}^{2} c ( {D}_{+} + {D}_{-} )}{R T} ,$$

the conductivity is positively correlated to the local concentration of lithium ions (c) and the diffusivity. With minor amounts of solvent/additives to guarantee diffusivity, the presence of the CTC gives rise to increased conductivity.

According to the Jorne model, the transference number (tᵢ) is expressed in the following equation:

$${t}_{i} = \frac{{F}^{2} {z}_{i} {u}_{i} {c}_{i a v g} + \frac{{q}_{2}^{2}}{μ} [ 1 - \frac{{I}_{0} ( \frac{{r}_{o}}{λ} ) {I}_{2} ( \frac{{r}_{o}}{λ} )}{{I}_{1}^{2} ( \frac{{r}_{0}}{λ} )} ]}{{k}_{a v g} + \frac{{q}_{2}^{2}}{μ} [ 1 - \frac{{I}_{0} ( \frac{{r}_{o}}{λ} ) {I}_{2} ( \frac{{r}_{o}}{λ} )}{{I}_{1}^{2} ( \frac{{r}_{0}}{λ} )}}$$

where F is the Faraday constant, uᵢ is the ion mobility, c_{iavg} is the average ion concentration, q₂ is the constant surface charge density, λ is the Deby length, k_{avg} is the average conductivity, μ is the viscosity, rₒ is the radius of the pore, I₀, I₁, I₂ are the modified Bessel functions of the first kind of the order zero, one and two. When the surface charge is negative and the pore size and the Debye screening length is about the same order (rₒ/λ˜I), the transference number of the cation will approach 1.

Based on this information, for a charge-transfer co-polymer electrolyte (CTCP) to exhibit enhanced conductivity, three factors are advantageous:
(1) Sufficient diffusivity from added solvent/polymer;
(2) Negative surface charge caused by charge-separation due to the formation of charge-transfer complex; and
(3) Sub-nanometer space between polymer chains (negatively charged surfaces).

FIG. 4B illustrates a schematic diagram showing both high lithium concentration through the charge-transfer complex polymer (CTCP) interface and high lithium mobility through the addition of electrolyte additives. The CTCP enhances the local charge concentration of the lithium due to overlapping of double electric layer. Higher concentration of lithium (that originates from the use of CTCP) plus higher lithium mobility (originates from the addition of additives) is thought to provide high lithium-ion conductivity.

According to the implementations provided by the present disclosure, various embodiments of CTCP co-electrolytes can be prepared by adding certain amount of succinonitrile, tetracyanoethelated pentaerythritol and BMP-TFSI (ionic liquid) respectively to a charge-transfer complex polymer (CTCP) comprising poly(dimethyl substituted phenylene sulfide), chloranil and LiTFSI. The CTCP increases local dielectric constant and local lithium concentrations while the additives increased the lithium mobility. As a result, the CTCP co-electrolytes show >10⁻⁴ S/cm conductivity at room temperature.

Historically, conventional polymer electrolytes rely solely on segmental motion of the polymer chains, and therefore, the conductivity is limited by the nature of polymer and is generally <10⁻⁵ S/cm at RT. In contrast, the lithium transport of the present disclosure is decoupled from segmental motion of the backbone. The CTCP serves as a local lithium-ion concentration enhancer and the interface between the CTCP and additives (e.g., solvent) serves as a pathway for lithium ion with high mobility. As used herein, the term “CTCP” refers to a polymer having both an electron donor and an electron acceptor. One or both of the electron donor and electron acceptor may be polymers. In select embodiments, a CTCP may include a polymeric electron donor and a small molecule electron acceptor. As a result, the CTCP has the potential to reach higher ionic conductivity and transference numbers than conventional polymer electrolyte while maintaining solid-state form.

In some embodiments, the polymer electrolyte comprises, consists of, or consists essentially of: a polymer electron donor, an electron acceptor, a lithium salt, and a solvent.

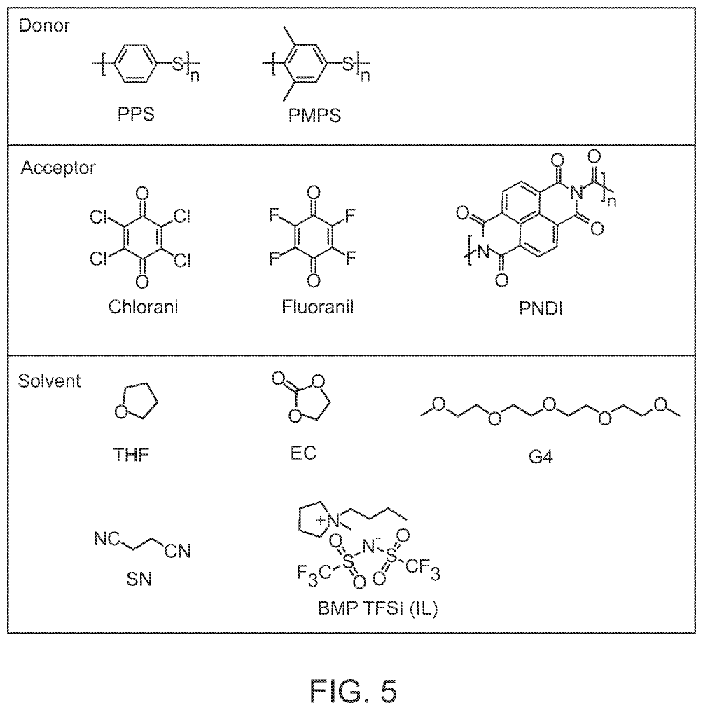

In select embodiments, the polymer electron donor may be polyphenylene sulfide (PPS), polymethylphenylsilane (PMPS), and/or poly(ethylene oxide) (PEO). In these and other embodiments, the electron acceptor may be Chloranil, Fluoranil, N,N′-bis(2-phosphonoethyl)-1,4,5,8-naphthalenediimide (PNDI), 2,3-Dichloro-5,6-dicyano-1,4-benzoquinone (DDQ), and/or an oxidizing agent. Any type of oxidizing agent that can act as an electron acceptor may be used. For example, in some embodiments, the oxidizing agent may be iodine, 1,4-Benzoquinone (BQ), chloral, Tetracyanoquinodimethane (TCNQ), DDQ, chloranilic acid, and/or any polymeric version of these organic electron acceptors. The lithium salt may be Lithium bis(trifluoromethanesulfonyl)imide (LiTFSI), in some embodiments. The solvent may be one or more of the following: tetrahydrofuran (THF), SN, EC, BMP TFSI (IL), and/or G4. FIG. 5 shows the chemical structures of various possible polymer electron donors, electron acceptors, and solvents for the disclosed electrolytes.

In some embodiments, the polymer electrolyte comprises one or more block copolymers composed of monomers in which one of the monomers contains electron-rich pi systems and the other of the monomers contains electron-poor pi systems. Monomers with electron-rich pi systems include vinyl Imidazole and N-Vinyl Carbazole. Monomers with electron-poor pi systems include methylene glutaronitrile, cinnamonitrile, butyl methacrylate, thiazolo[5,4-d]thiazole, benzo[1,2-d:4,5-d′]bisthiazole, naphtho[1,2-c:5,6-c′]bis[1,2,5]thiadiazole, and thieno[3,2-b]thiophene-2,5-dione.

The block copolymers may be combined with a salt (e.g., a lithium-ion salt) to form the polymer electrolyte. The salt may be LiTFSI, if desired. In some embodiments, one of the polymers containing electron-rich pi systems is combined and blended with another polymer containing electron-poor pi systems. The blended polymers are combined with a salt to create a polymer electrolyte.

The disclosed mixtures of electron-poor pi groups and electron-rich pi grounds are capable of dissociating the salts more easily than either of the polymer blocks could on its own. In some embodiments, the polymer/salt matrix can be maintained above the glass transition temperature to work well and have even further improved ionic conductivity.

The disclosed polymer electrolytes may have an ionic conductivity of at least 1×10⁻⁴ S/cm or at least 1×10⁻³ S/cm at room temperature (25° C.). In select embodiments, the polymer electrolyte may contain between 0.5 wt %-50 wt % solvent, such as between 0.5 wt %-5 wt %, 0.5 wt %-15 wt %, 5 wt %-25 wt %, or 10 wt %-30 wt % solvent.

The presently disclosed electrolytes can be prepared by any suitable technique. For example, in some embodiments, the electrolytes are prepared by speed mixing. In select embodiments, a high shear mixer may be used to prepare the electrolytes. The electrolytes may be prepared by ultrasonic mixing and heat melting/mixing, if desired. In these and other embodiments, the electrolytes may be formed by wet spray coating, drop casting, and/or dip coating.

### Experimental Examples

### Example 1

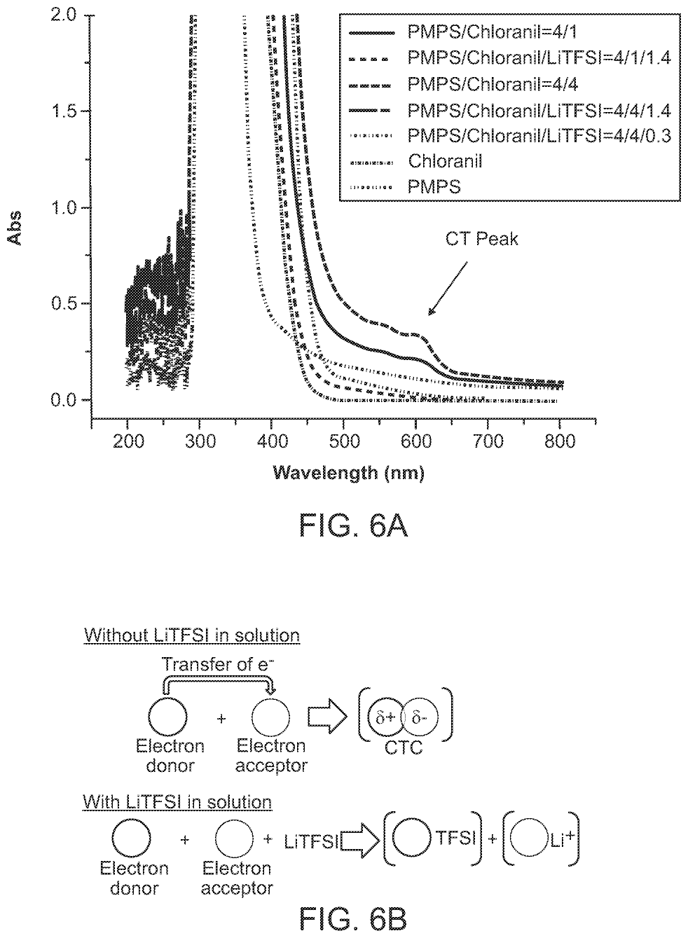

Exemplary charge transfer complexes (CTCs) were formed containing a lithium-ion salt and tested against comparative examples without a lithium-ion source present. In particular, mixtures containing PMPS/Chloranil in THE with and without LiTFSI were created and UV/Vis spectra were obtained for each mixture using THF. The UV/Vis spectra are shown in FIG. 6A. FIG. 6B shows schematic diagrams that may explain how the LiTFSI disrupts formation of the CTCs.

Compared to PMPS alone and chloranil alone, the spectrum of PMPS mixed with chloranil showed a characteristic absorbance signal at 600 nm at a molar ratio of 4/1 and as the ratio of chloranil increased to 4/1, the intensity of the absorbance signal also increased, which is indicative of the formation of charge transfer complex in solution. However, when LiTFSI are added, the characteristic peaks disappeared. This could be due to adsorption of Li⁺ to the PMPS backbone and TFSI⁻ to chloranil, which disrupts the formation of CTC.

The observations suggest that PMPS and chloranil should have potential to form charge-transfer complex at solid state. And due to the limited diffusion rate of lithium salt at dryer state, even with LiTFSI, charge-transfer complex could still form.

The Zeta potentials for each mixture were also calculated, and the values are shown below in Table 1.

TABLE 1
Results of Zeta Potential in Ethanol

| Entry | Sample | Zeta potential | |
|---|---|---|---|
| 1 | PMPS | +28.57 | mV |
| 2 | PMPS/Chloranil = 4/1 | +3.174 | mV |
| 3 | PMPS/Chloranil = 4/4 | −3.441 | mV |
| 4 | PMPS/LiTFSI = 4/1.4 | −43.74 | mV |
| 5 | PMPS/Chloranil/LiTFSI = 4/1/1.4 | 53.73 | mV |

In all samples shown in Table 1, a PMPS concentration of 3 μg/mL was used.

When chloranil was added with or without LiTFSI, the Zeta potential reversed either from negative to positive or from positive to negative. Especially when there is only PMPS and LiTFSI dispersed in ethanol, the surface of the particles exhibited negative charges, indicating that the diffuse layer of PMPS is TFSI⁻ dominant. When chloranil is added, the surface of particles become negatively charged and the vicinity of the surface (diffuse layer) become Li⁺ dominant. This suggests that the addition of chloranil enabled charge separation at the polymer surface, and thus a lithium-dominant surface.

### Example 2

In this experimental example, the effect of solvent amount and type was studied. Various polymer electrolyte mixtures were prepared by speed mixing. First, LiTFSI and solvent were speed-mixed at rpm of 2750 for 10 min to form a homogeneous liquid. Then polymer powder and chloranil powder were added to the LiTFSI/solvent solution, and speed mixed again at 2750 rpm for 10 min. The as-prepared mixture was then kept at 80° C. overnight to facilitate formation of a charge-transfer complex. The ionic conductivity of the resulting mixture was then measured with different solvent amounts.

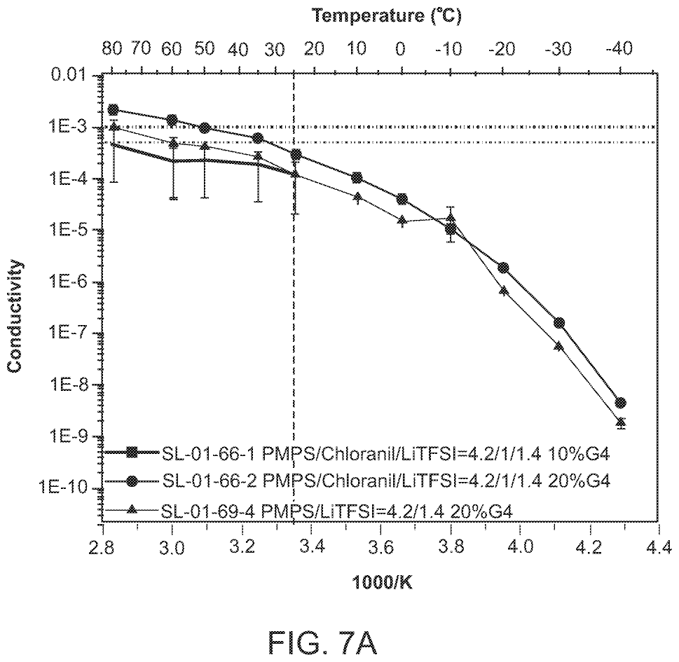

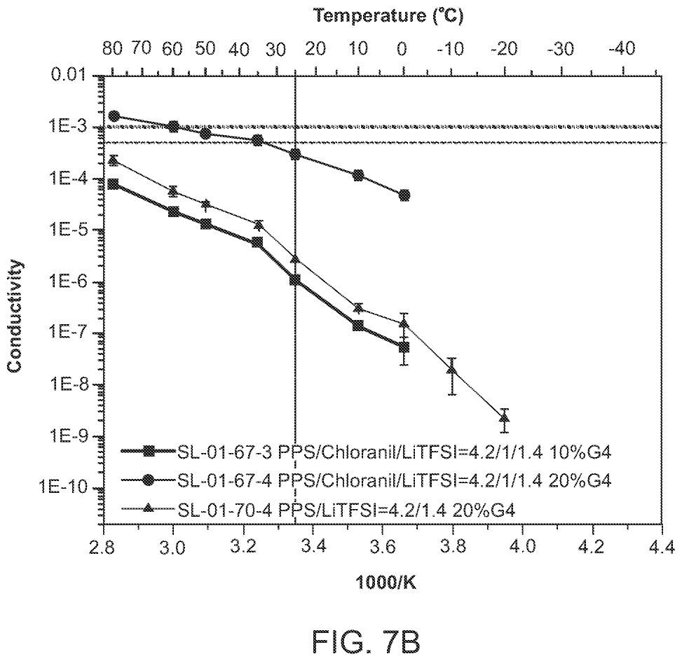

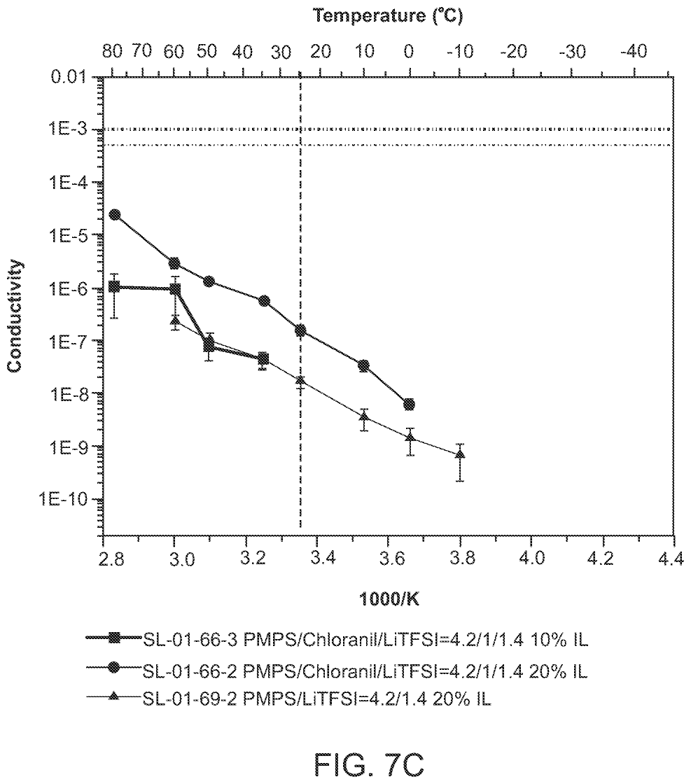

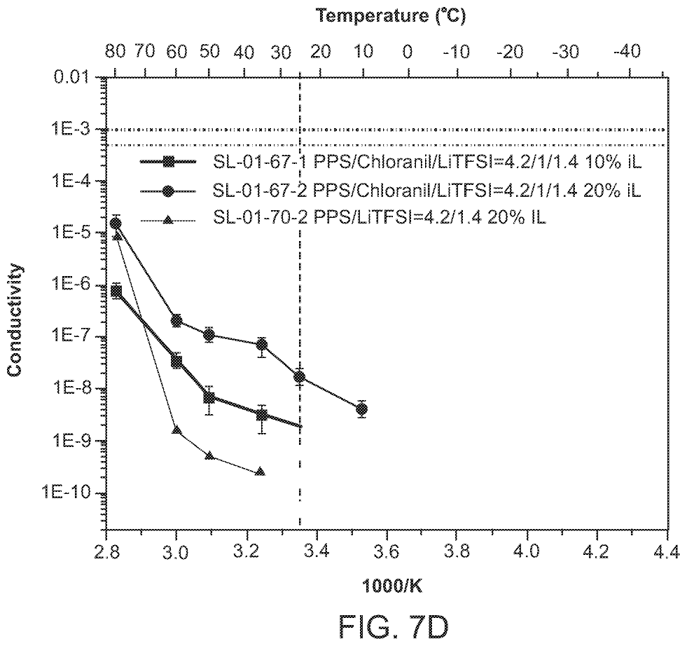

FIG. 7A shows the ionic conductivity of mixtures containing PMPS and LiTFSI at different concentrations of G4 solvent, with and without Chloranil; FIG. 7B shows the ionic conductivity of mixtures containing PPS and LiTFSI at different concentrations of G4 solvent, with and without Chloranil; FIG. 7C shows the ionic conductivity of mixtures containing PMPS and LiTFSI at different concentrations of IL solvent, with and without Chloranil; and FIG. 7D shows the ionic conductivity of mixtures containing PPS and LiTFSI at different concentrations of IL solvent, with and without Chloranil.

In both cases of PPS and PMPS, at a molar ratio of sulfur/chloranil/LiTFSI=4/1/1.4, the more solvent that was added, the higher the ionic conductivity that resulted. At 20 wt % of G4, both PMPS/chloranil/LiTFSI (FIG. 7A) and PPS/chloranil/LiTFSI (FIG. 7B) showed a conductivity of 0.3 mS/cm, higher than 10 wt % of G4. But at 10 wt % of G4, PMPS/Chloranil/LiTFSI showed much high conductivity (0.12 mS/cm)—PPS/Chloranil/LiTFSI (0.0012 mS/cm). The same trend was observed for ionic liquid (IL). The sample with 20 wt % of IL showed higher conductivity than that 10 wt % of IL for both PMPS (FIG. 7C) and PPS (FIG. 7D), however the conductivities with IL are much lower than those with G4.

### Example 3

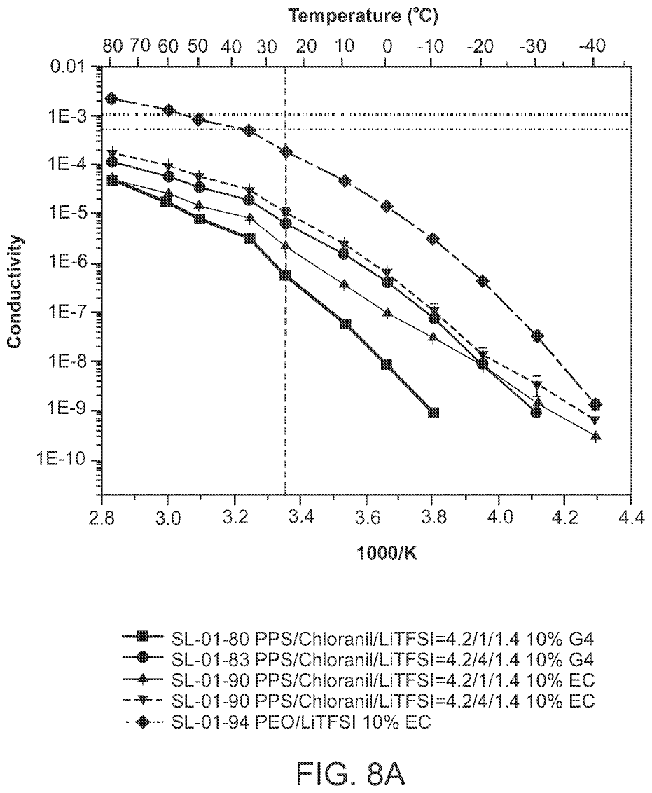

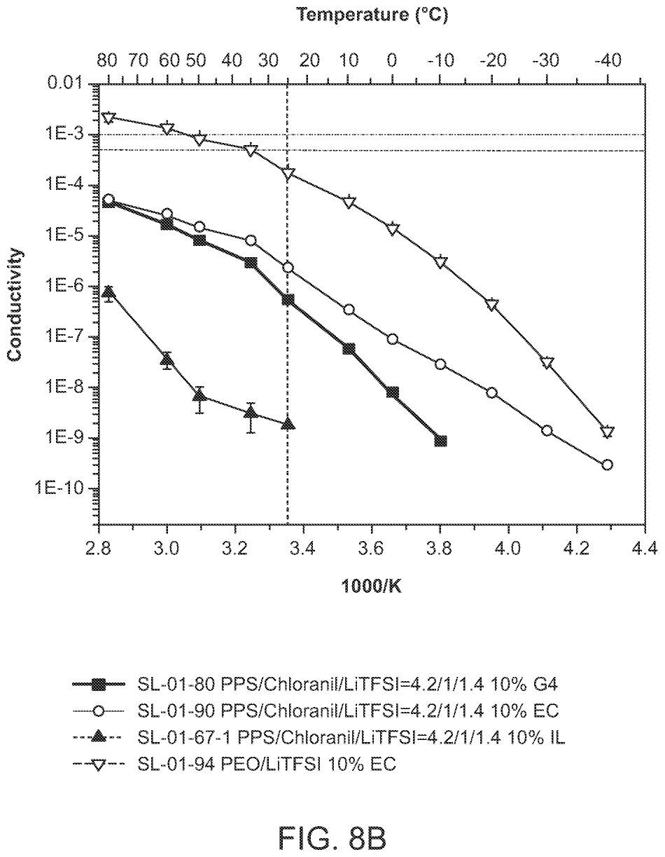

In this experimental example, the ionic conductivity of different types of solvents (G4, EC, IL at 10 wt %) were evaluated. FIGS. 8A-8B show the ionic conductivities of various polymer electrolytes. As shown in FIGS. 8A-8B, with the same ratio of sulfur/Chloranil/LiTFSI, the conductivity follows the following trend: EC>G4>>IL. However, the conductivities are still all lower than 0.01 mS/cm at RT and much lower than PEO/LiTFSI with 10 wt % of EC (0.18 mS/cm).

### Example 4

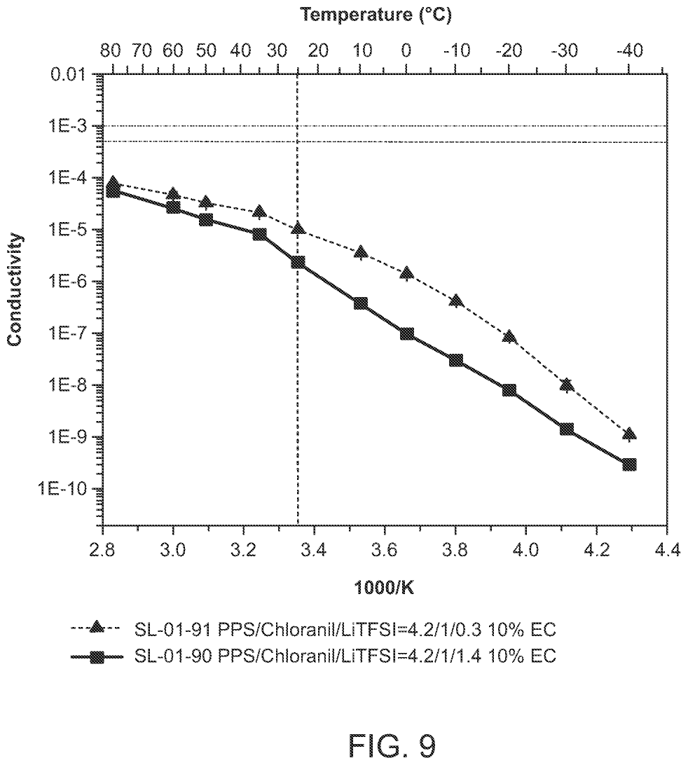

In this experimental example, the effect of amount of salt was evaluated. FIG. 9 shows conductivity measurements for two polymer electrolytes. The samples were prepared in the same method as that in Example 3 via speed-mixing. With a lower amount of lithium salt (PPS/Chloranil/LiTFSI=4.2/1/0.3), the conductivity increased from 0.002 mS/cm to 0.01 mS/cm, suggesting that tuning the lithium concentration could further increase the conductivity in the future.

### Example 5

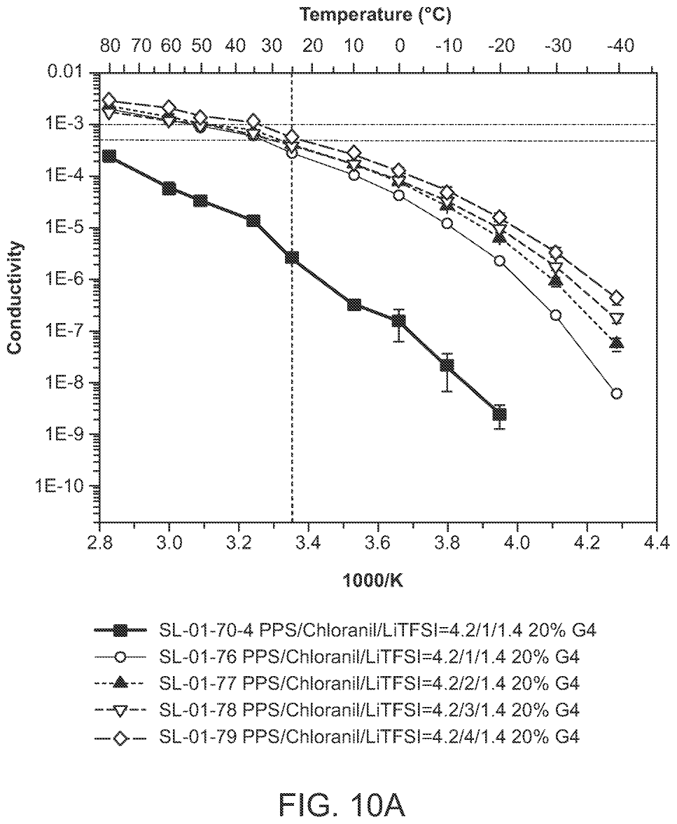

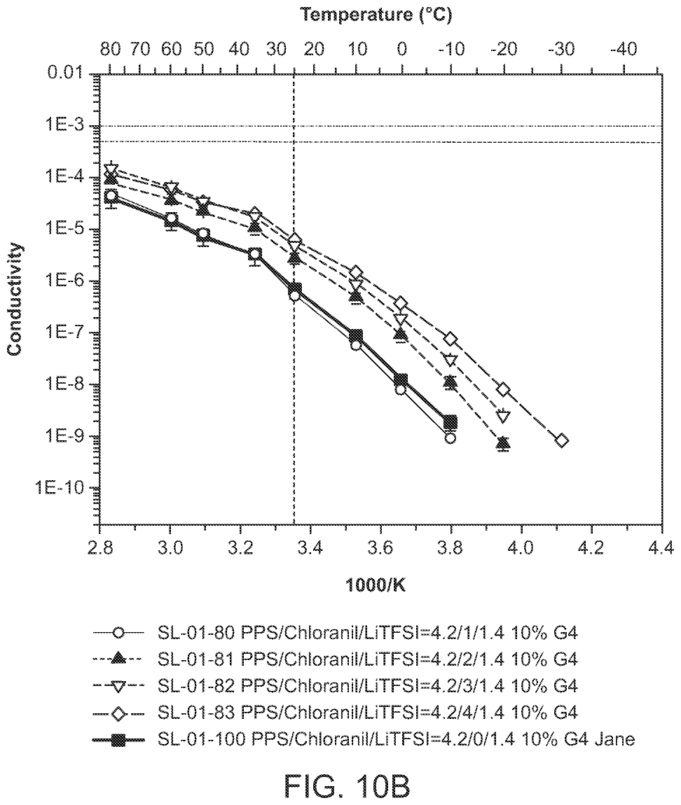

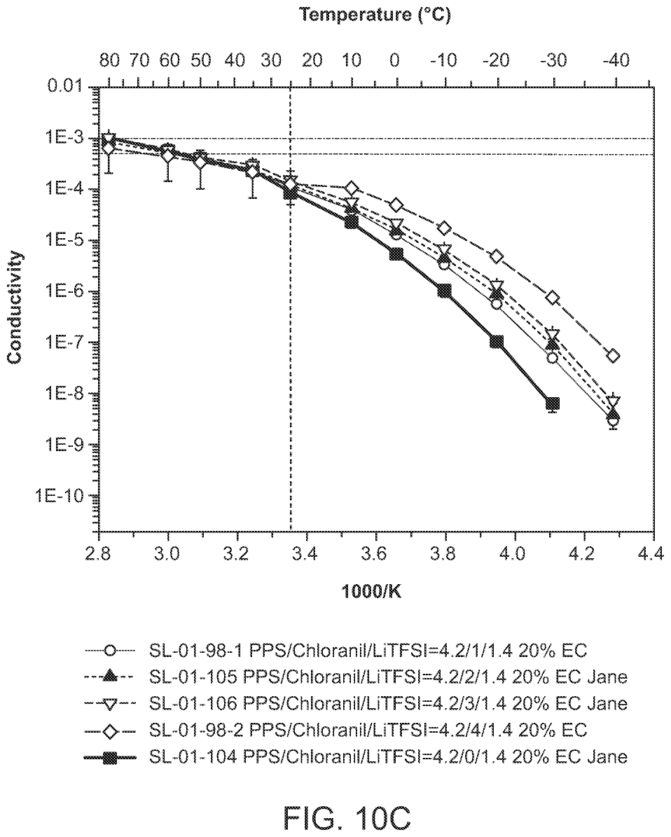

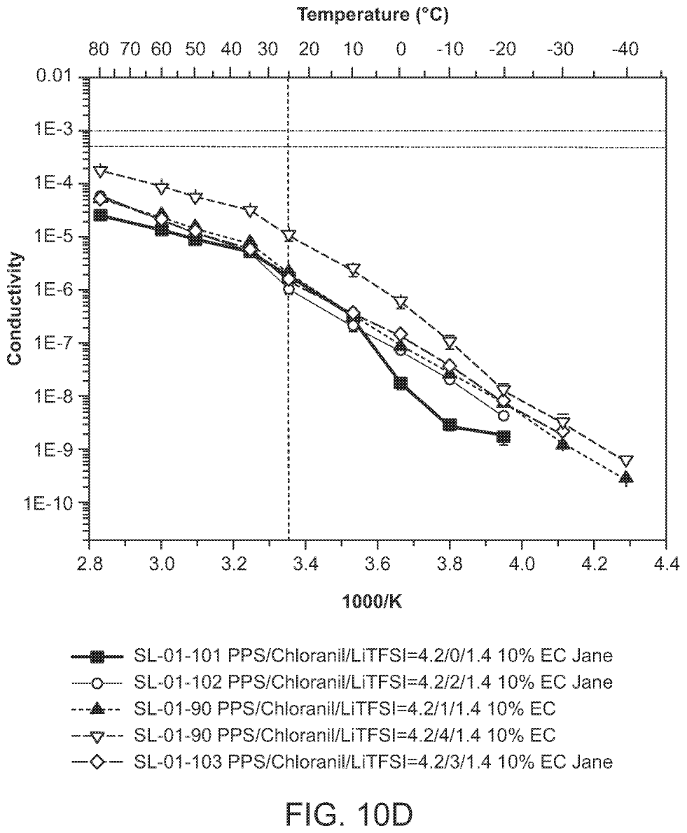

In this experimental example, the effects of acceptor quantity and type were considered. FIGS. 10A-10D show conductivity measurements for different types and amounts of acceptors. FIGS. 10A-10B show conductivity data for PPS/Chloranil/LiTFSI (varying amounts of chloranil) in G4 solvent. FIGS. 10C and 10D show conductivity data for PPS/Chloranil/LiTFSI (varying amounts of chloranil) in EC solvent.

In FIG. 10A, with 20 wt % G4, as the PPS/chloranil ratio dropped from 4 to 0, the ionic conductivity also linearly dropped, with sulfur/chloranil/LiTFSI=4.2/4/1.4 reaching the highest conductivity of 0.6 mS/cm at RT and 1 mS/cm at 35° C. When the G4 content is at 10 wt %, the conductivity is still linearly related to the amount of chloranil, although the conductivity consistently dropped by 1 order of magnitude (FIG. 10B). FIGS. 10C-10D showed the conductivity of sulfur/Chloranil/LiTFSI with either 20 wt % EC or 10 wt % EC. Similarly, the higher the chloranil content, the higher the conductivity and that 20 wt % EC is 1 order of magnitude higher than 10 wt % EC. However, at 20 wt %, CTCP with G4 has higher conductivity than EC.

### Example 6

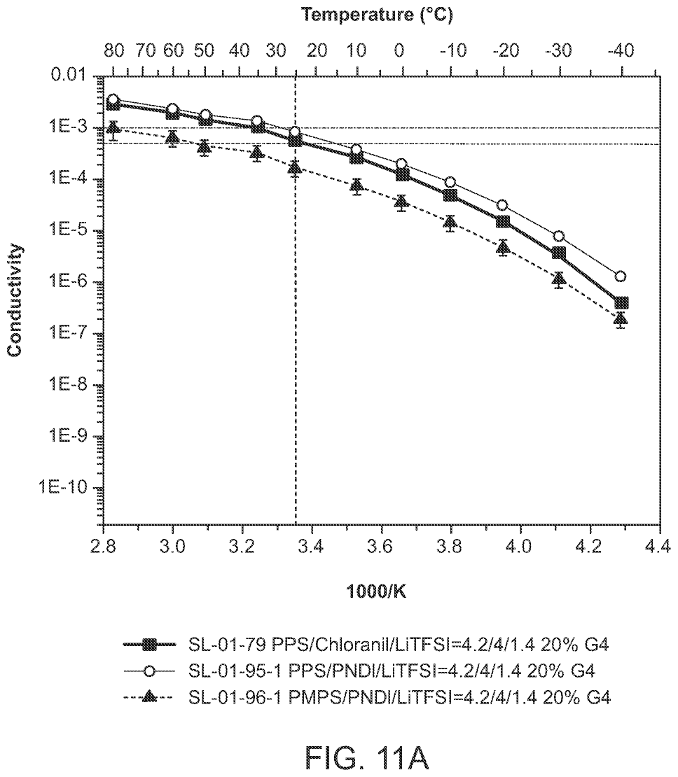

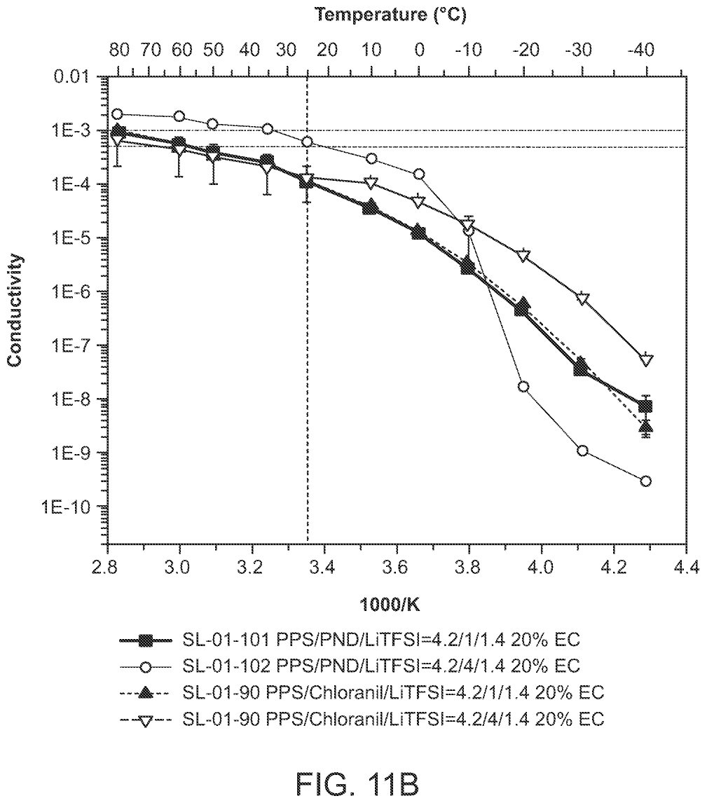

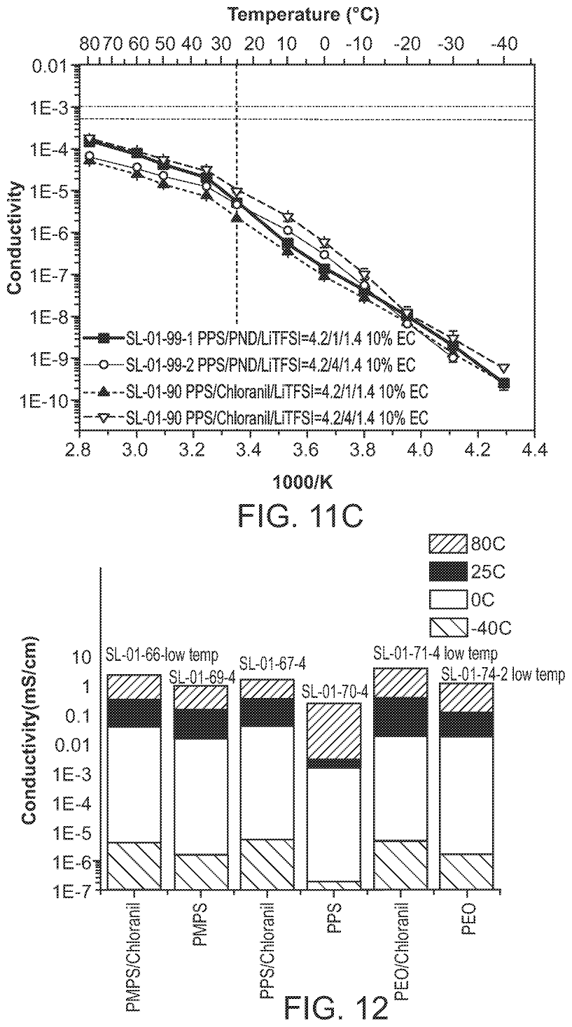

FIGS. 11A-11C show conductivity data for various polymer electrolytes. In particular, a polymeric version of electron acceptor PNDI was explored. (The chemical structure of PNDI is shown in FIG. 5). As shown in FIGS. 11A-11B, when PPS is paired with PNDI instead of chloranil, the ionic conductivity becomes higher either with 20 wt % G4 or 20 wt % EC. However, when only 10 wt % EC is used, chloranil showed higher ionic conductivity than PNDI at the same donor/acceptor/lithium ratio (FIG. 11C).

### Example 7

FIG. 12 shows the measured ionic conductivity for various polymers (PPS, PMPS, PEO) with and without the addition of G4. In all experimental mixtures shown in FIG. 12, 20 wt % G4 was used, and samples were prepared by speed-mixer. The electron donor/acceptor ratio was 4/1 for all samples.

### Example 8

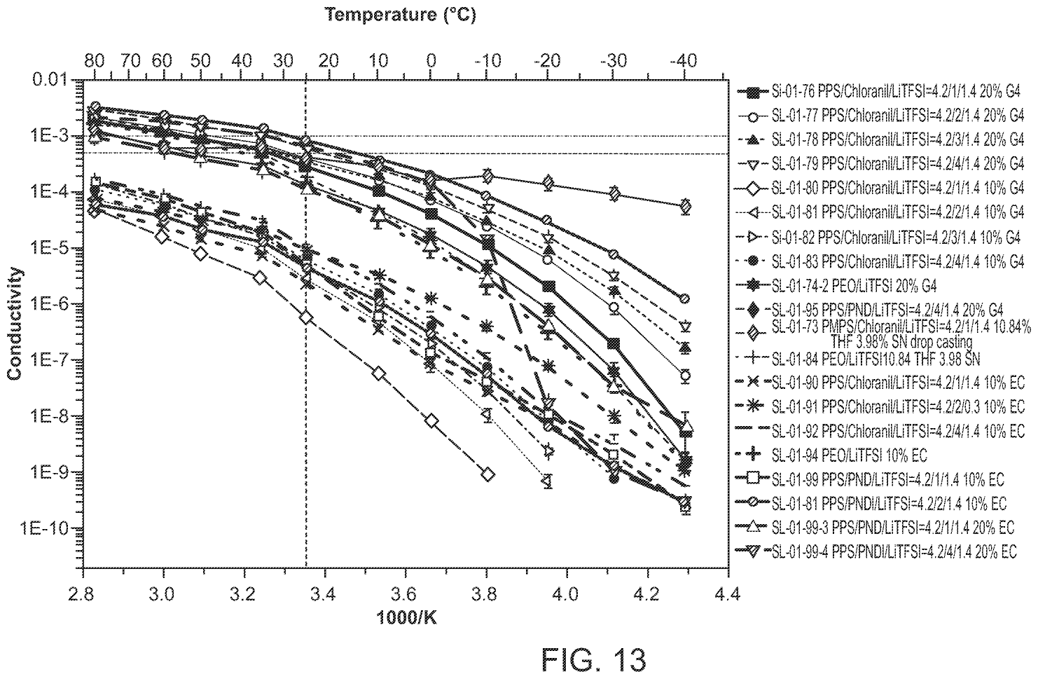

FIG. 13 shows conductivity data for various samples prepared by speed-mixing.

### Example 9

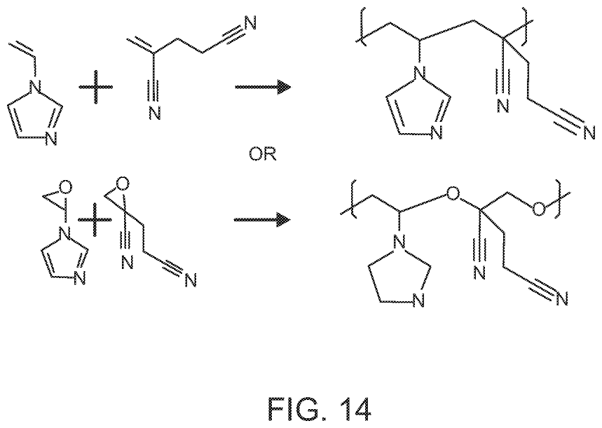

In this experimental example, vinyl Imidazole (an electron-rich π-donor group), methylene glutaronitrile (an electron-poor π-acceptor group) and LiTFSI (a salt) are dissolved in a solution of THF. An initiator, such as AIBN is added, and the mixture heated at 65C until polymerized. In solution, the MGN and Vim pair up to form a charge transfer complex. On removal of the solvent, a homogenous orange plastic remains, and the salt is dissociated. The resulting polymer has ionic conductivity of 5×10⁻⁴ S/cm. FIG. 14 shows chemical reaction diagrams for Example 9.

### Example 10

In this experimental example, N-Vinyl Carbazole (an electron-rich π-donor group), cinnamonitrile (an electron-poor π-acceptor group) and Zinc Triflate (a salt) are dissolved in a solution of THF. An initiator, such as AIBN is added, and the mixture heated at 65C until polymerized. In solution, the VCz and CNN pair up to form a charge transfer complex and the color changes from colorless to purple. On removal of the solvent, a homogenous purple plastic remains. The resulting polymer has ionic conductivity of 6×10⁻⁶ S/cm.

### Example 11

In this experimental example, N-Vinyl Carbazole (an electron-rich π-donor group) and butyl methacrylate (an electron-poor π-acceptor group) are dispersed in a solution of THF. An initiator such as AIBN is added and the mixture heated at 65C until polymerized. On removal of the solvent, a homogenous white plastic remains. 98% sulfuric acid is added and mixed into the polymer forming a green solid, which is then dried at 120° C. overnight. The resulting polymer has ionic conductivity of 1.5×10⁻⁴ S/cm.

1. A polymer electrolyte for an electrochemical cell, the polymer electrolyte comprising:
a polymer electron donor;
an electron acceptor;
a lithium salt; and
a solvent.

2. The polymer electrolyte of claim 1, wherein the polymer electron donor is selected from the group consisting of: polyphenylene sulfide (PPS), polymethylphenylsilane (PMPS), and poly(ethylene oxide) (PEO).

3. The polymer electrolyte of claim 1, wherein the electron acceptor is selected from the group consisting of: Chloranil, Fluoranil, N,N′-bis(2-phosphonoethyl)-1,4,5,8-naphthalenediimide (PNDI), 2,3-Dichloro-5,6-dicyano-1,4-benzoquinone (DDQ), and an oxidizing agent.

4. The polymer electrolyte of claim 1, wherein the lithium salt is lithium bis(trifluoromethanesulfonyl)imide (LiTFSI).

5. The polymer electrolyte of claim 1, wherein the solvent is selected from the group consisting of: tetrahydrofuran (THF), SN, EC, BMP TFSI (IL), and G4.

6. The polymer electrolyte of claim 1, wherein the polymer electrolyte has an ionic conductivity of at least 1×10⁻⁴ S/cm at 25° C.

7. The polymer electrolyte of claim 1, wherein the polymer electrolyte has an ionic conductivity of at least 1×10⁻³ S/cm at 25° C.

8. The polymer electrolyte of claim 1, wherein the polymer electrolyte contains between 0.5 wt %-15 wt % solvent.

9. The polymer electrolyte of claim 1, further comprising a charge-transfer complex polymer (CTCP).

10. The polymer electrolyte of claim 9, wherein the CTCP enhances local lithium concentration due to an overlapping of a double electric layer.

11. The polymer electrolyte of claim 9, wherein a high local lithium concentration and a high lithium mobility originate from the CTCP.

12. An electrochemical cell comprising the polymer electrolyte of claim 1.

13. A battery comprising:
a polymer electrolyte;
a solution; and
an initiator;
wherein the polymer electrolyte comprises:
one or more block copolymers, wherein the one or more block copolymers are comprised of an electron-rich pi system monomer and an electron-poor pi system monomer; and
a salt.

14. The battery of claim 13, wherein the polymer electrolyte is above its glass transition temperature.
